(19) United States
(12) Patent Application Publication
(10) Pub. No.: US 2012/0318823 A1
(43) Pub. Date: Dec. 20, 2012

(54) HOT WATER SUPPLY DEVICE AND COLD/HOT WATER DISPENSER USING THE SAME

(75) Inventor: Hee-Jong Yoon, Siheung-Si (KR)

(73) Assignee: WINIX INC., Siheung-si (KR)

(21) Appl. No.: 13/315,114

(22) Filed: Dec. 8, 2011

(30) Foreign Application Priority Data
Jun. 20, 2011 (KR) 10-2011-0059778

(51) Int. Cl. B67D 7/80; F24H 9/20; F24H 1/20

(52) U.S. Cl. 222/146.1; 392/449

(57) ABSTRACT

A hot water supply device of a cold/hot water dispenser capable of preventing hot water kept in a hot water storage unit from flowing backward to thus minimize a heat loss and preventing water kept in the hot water storage unit from being expanded to increase pressure to thus stably guide discharging of hot water is provided.

The hot water supply device of a cold/hot water dispenser includes: a hot water storage unit allowing water to be introduced thereto and discharged therefrom and having a heating device for heating water; an outlet cock discharging hot water kept in the hot water storage unit to the outside; and an auxiliary storage unit storing water flowing from the hot water storage unit when the water stored in the hot water storage unit is heated according to an operation of a heating device to exceed the capacity of the hot water storage unit.

### CROSS-REFERENCE TO RELATED APPLICATION

This application claims priority to and the benefit of Korean Patent Application No. 10-2011-0059778 filed in the Korean Intellectual Property Office on Jun. 20, 2011, the entire contents of which are incorporated herein by reference.

### BACKGROUND OF THE INVENTION

(a) Field of the Invention

The present invention relates to a hot water supply device and a cold/hot water dispenser using the same and, more particularly, to a hot water supply device capable of preventing hot water kept in a hot water storage unit from flowing backward to thus minimize a heat loss and preventing water kept in the hot water storage unit from being expanded to increase pressure to thus stably guide discharging of hot water.

(b) Description of the Related Art

Recently, as interest in potable water is increasing, spring water sold in stores is commonly used in homes, offices, businesses, and the like.

Spring water is sold in a bottle, or the like, so as to be kept in a refrigerator, or the like, and used when required, or cooled or heated at a certain temperature by using a cold/hot water dispenser (or a chiller/heater) so as to be selectively used as cold water or hot water.

The chiller/heater has a structure in which a spring water container is mounted upside down, and includes a storage tank keeping a certain amount of water of the spring water container in storage.

The storage tank is connected to a cold water tank and a hot water tank, and water stored in the cold water tank and hot water tank is cooled or heated by a cooling device and a heating device installed in the cold water tank and the hot water tank, respectively.

A different type of chiller/heater is configured to include a cold water thank and a hot water tank, omitting a storage tank, and allow water to be introduced to the hot water tank through the cold water tank.

An outlet cock is connected to the cold water tank and the hot water tank through a pipe line, and a user may discharge cold water or hot water by using the outlet cock to use it.

However, in the hot water supply device, as water is heated in the hot water tank, the volume of hot water is expanded, so part of hot water flows backward to the storage tank or cold water tank.

When hot water flows backward to the storage tank or cold water tank, heated hot water is mixed with water held in the tank, making a heat loss.

Thus, a great deal of energy is required to cool or heat water, and when the hot water is mixed with the water held in the tank, it is difficult to maintain an appropriate temperature level of cold water and hot water required in the chiller/heater.

Also, a chiller/heater in which an air bladder is installed within a hot water tank to adjust a water level of the hot water tank to thus constantly store a certain amount of hot water in the hot water tank is also used as a different type of chiller/heater, but in this case, the internal structure of the hot water tank may be complicated, and since the air bladder is hinge-fixed and ascends and descends according to a water level, it is highly likely to be broken when used for a certain period of time in terms of structure.

Recently, in order to prevent germs, or the like, which may propagate within the spring water container, the cold water tank and the hot water tank, a chiller/heater, which is directly connected to tap water, stores water in a pipe line configured to have a pipe form or in a closed storage container, and includes a refrigerant pipe line of a refrigeration cycle or a heater along an inner side or an outer side thereof to cool or heat water maintained in the pipe line to have a certain temperature and store the same, has been developed and used. However, in this chiller/heater, the storage unit configured as a pipe is fully filled with water therein, so when heat is heated, the volume of the heated water expands to have a high pressure, and in this state, when the hot water is discharged, the hot water is discharged with a high pressure, having a high possibility in which the user may be scalded.

In addition, the expansion of hot water in volume is highly likely to damage the pipe line storing hot water.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a hot water supply device and a cold/hot water dispenser using the same having advantages of preventing hot water kept in a hot water tank from flowing backward to thus minimize a heat loss and preventing water kept in a hot water storage unit from being expanded to increase pressure to thus stably guide discharging of hot water.

An exemplary embodiment of the present invention provides a hot water supply device including: a hot water storage unit allowing water to be introduced thereto and discharged therefrom and having a heating device for heating water; an outlet cock discharging hot water kept in the hot water storage unit to the outside; and a pressure adjustment unit for adjusting the pressure of the hot water storage unit when water kept in the hot water storage unit is heated according to an operation of the heating device so as to be thermally expanded to increase pressure in excess of the capacity of the hot water storage unit.

The hot water storage unit may be configured to have a form of a tank or a pipe line, the pressure adjustment unit adjusting the pressure in the wake of thermal expansion may include an auxiliary storage placed at an upper side of the hot water storage unit to receive a thermally expanded liquid in the wake of the increased pressure, and water stored in the auxiliary storage unit may flow to the hot water storage unit according to self-weight when the pressure of the hot water storage unit is lowered. An air outlet may be formed on the auxiliary storage unit.

According to an embodiment of the present invention, in the hot water supply device of a cold/hot water dispenser, when water stored in the hot water storage unit is heated to exceed the capacity of the hot water storage unit, water flows to be temporarily stored in the auxiliary storage unit, whereby water is prevented from flowing back to a different tank so as to be mixed, and thus, a heat loss is not made.

Therefore, energy for cooling/heating water can be saved, and an appropriate temperature of cold water and hot water required for the cold/hot water dispenser can be constantly precisely maintained.

Also, although water of the hot water storage unit is heated to have an expanded volume and increased pressure, the hot water storage unit can be prevented from being damaged, and thus, when water is discharged from the hot water storage unit, water can be stably discharged without causing a possibility of scald.

### BRIEF DESCRIPTION OF THE DRAWINGS

FIG. 1 is a view showing the configuration of a hot water supply device of a cold/hot water dispenser according to an embodiment of the present invention.

FIG. 2 is a view showing a hot water storage unit, which constitutes the hot water supply device of a cold/hot water dispenser according to an embodiment of the present invention, configured in the form of a pipe line.

### DETAILED DESCRIPTION OF THE EMBODIMENTS

An exemplary embodiment of the present invention will hereinafter be described in detail with reference to the accompanying drawings.

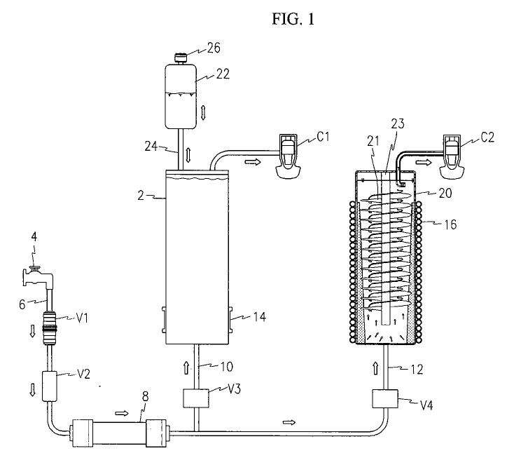

FIG. 1 is a view showing the configuration of a hot water supply device of a cold/hot water dispenser according to an embodiment of the present invention. The hot water supply device according to an embodiment of the present invention includes a hot water storage unit 2 which is provided with water, heats water to have a certain temperature, and stores the heated water.

As for water supplied to the hot water storage unit 2, it is illustrated that the hot water storage unit 2 is connected to a faucet 4 to receive water through an inlet pipe line 6, and here, the water passes through a filter 8 to filter out a foreign object, or the like, and filtered water is supplied to the hot water storage unit 2, but the present invention is not limited thereto, and spring water sold on the market, mineral water, or the like, may be supplied through the inlet pipe line 6.

The hot water storage unit 2 is configured in the form of a storage tank having a certain capacity to allow a certain amount of hot water to be stored therein.

Water, which has passed through the filter 8, flows to the hot water storage unit 2 and a cold water storage unit 20 through two branched inflow pipe lines 10 and 12

A check valve V1 and a decompression valve V2 may be provided on the inlet pipe line 6, and solenoid valves V3 and V4 that supplies or cuts off water to the hot water storage unit 2 and the cold water storage unit 20 may be provided on the inflow pipe lines 10 and 12.

The solenoid valves V3 and V4 operate under the control of a controller (not shown) upon receiving signals of water level sensors (not shown) of the hot water storage unit 2 and the cold water storage unit 20.

A heating device 14 is installed on the hot water storage unit 2, and a cooling device 16 is installed on the cold water storage unit 20, respectively, to heat and cool water stored in the hot water storage unit 2 and the cold water storage unit 20 to have a certain temperature.

The heating device 14 may be configured as a general heater generating heat upon receiving power, and as the cooling device 16, a refrigerating cycle circulating a refrigerant to perform a cooling operation, or a thermoelectric cooling element may be used, so a detailed description thereof will be omitted.

Also, outlet cocks C1 and C2 may be installed at the hot water storage unit 2 and the cold water storage unit 20 to discharge hot water and cold water to the outside.

When hot water stored in the hot water storage unit 2 is heated, the liquid in the hot water storage unit 2 is thermally expanded to exceed the internal capacity of the hot water storage unit 2. Thus, in an embodiment of the present invention, a unit for lowering the pressure in the wake of the thermal expansion is provided, and such a unit may be an auxiliary storage unit 22 for temporarily storing the thermally expanded hot water.

The auxiliary storage unit 22 is a container for storing a certain amount of liquid, and has a structure connected to the hot water storage unit 2 through an outflow pipe line 24. Accordingly, when the water stored in the hot water storage unit 2 is heated by the heating device 14 to have an expanded volume, the internal pressure of the hot water storage unit 2 is increased. Then, hot water by the amount exceeding the capacity of the hot water storage unit 2 is pushed into the auxiliary storage unit 22 according to the pressure within the hot water storage unit 2 through the outflow pipe line 24.

The auxiliary storage unit 22 is positioned at a lateral side or an upper side of the hot water storage unit 2. Hot water exceeding the capacity of the hot water storage unit 2 rises due to the internal pressure of the hot water storage unit 2 so as to be stored in the auxiliary storage unit 22, and when the water in the hot water storage unit 2 is discharged according to a manipulation of the outlet cock C1 to have a lower water level, water in the auxiliary storage unit 22 is returned to the hot water storage unit 2 according to self-weight.

An air outlet may be further formed on the auxiliary storage unit 22 in order to discharge a gas or air generated when the water in the hot water storage unit 2 is heated, to the outside.

Owing to the air outlet 26, the internal pressure of the hot water storage unit 2 and that of the auxiliary storage unit 22 are maintained to have a fixed level.

Also, preferably, an insulating member is installed on an outer side of the auxiliary storage unit 22 or the outflow pipe line 24. The reason is because, when water in the hot water storage unit 2 is discharged, water in the auxiliary storage unit 22 is returned to the hot water storage unit 2, and in this case, a heat loss can be minimized by the insulting member.

Various types of cold water storage units may be used, and in the present embodiment, a cold water storage unit 20 having a structure of guiding a flow of a liquid in a spiral form to thus enhance cooling efficiency is employed.

The cold water storage unit 20 is a container body having an internal space having a certain capacity, and the cooling device 16 of a hermetically closed type refrigerating cycle, which is generally well known, is provided to an outer circumference of the container body.

In FIG. 1, the cooling device 16 may be an evaporator of a generally used refrigerating cycle.

A spiral plate 21 is positioned in a lengthwise direction within the container body of the cold water storage unit 20 to allow a liquid introduced through the inflow pipe line 12 to have a spiral flow when moving upward.

The inflow pipe line 12 is connected to a lower portion of the cold water storage unit 20, and the cock C2 for discharging cold water is connected to an upper portion of the cold water storage unit 20.

The spiral plate 21 may be fixedly installed within the container body constituting the cold water storage unit 20 by using a support 23, or the like.

In the hot water supply device of a cold/hot water dispenser according to an embodiment of the present invention as described above, when water is supplied through the inlet pipe line 6, the water passes through the filter 8 and a foreign material, or the like, of the water is filtered out, and the filtered water flows to the hot water storage unit 2 and the cold water storage unit 20 through the inflow pipe lines 10 and 12, so as to be stored.

The water introduced into the respective storage units 2 and 22 is heated and cooled by the heating device 14 and the cooling device 16 to have a certain temperature and stored.

Here, as the water stored in the hot water storage unit 2 is heated according to an operation of the heating device 14, the volume of the water is expanded. In this case, when the water stored in the hot water storage unit 2 exceeds the capacity of the hot water storage unit 2, the internal pressure of the hot water storage unit 2 is increased and hot water within the hot water storage unit 2 is discharged to the outflow pipe line 24 so as to be pushed into the auxiliary storage unit 22.

According to this operation, the pressure within the hot water storage unit 2 according to the thermal expansion is not increased further, and rather, lowered.

When the hot water of the hot water storage unit 2 is introduced into the auxiliary storage unit 22, air therein is discharged to the outside through the air outlet 26, so the hot water can smoothly move.

In this state, when the user opens the outlet cock C1, the hot water in the hot water storage unit 2 is discharged to the outside, and at this time, since gas of a certain pressure or higher has been entirely discharged through the air outlet 26, the hot water is discharged with a relatively low pressure, rather than being gushed out.

When the hot water is discharged through the outlet cock C1, the hot water present in the auxiliary storage unit 22 is returned to the hot water storage unit 2 according to self-weight by air introduced through the air outlet 26.

When pressure is adjusted as the pressure within the hot temperature storage unit 2 is increased, the solenoid valve V3 is turned off to prevent the hot water within the hot water storage unit 2 from flowing backward. Although not shown, in order to control the solenoid valve V3, a water supply control unit generally used in the cold/hot water dispenser (or a chiller/heater) may be employed.

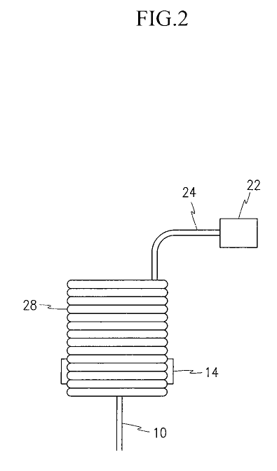

In the foregoing embodiment, the hot water storage unit 2 constituting the hot water supply device of a cold/hot water dispenser is configured in the form of a tank having a certain capacity, but the present invention is not limited thereto, and as shown in FIG. 2, a pipe may be wound in a shape of spiral coil to form a hot water storage unit 28 having a form of a pipe line and storing water at the inner side the coil.

Compared with the tank type hot water storage unit, the interior of the pipe line of the pipe line type hot water storage unit 28 is completely airtight, having an advantage that germs, or the like, cannot infiltrate.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

<Description of symbols>

| | |
|---|---|
| 2: hot water storage unit | 4: faucet |
| 6: inlet pipe line | 8: filter |
| 10, 12: inflow pipe line | 14: heating device |
| 16: cooling device | 20: cold water storage unit |
| 22: auxiliary storage unit | 24: outflow pipe line |
| 26: air outlet | C1, C2: outlet cock |
| V1: check valve | V2: decompression valve |
| V3, V4: solenoid valve | |

What is claimed is:

1. A hot water supply device comprising:
a hot water storage unit allowing water to be introduced thereto and discharged therefrom and having a heating device for heating water;
an outlet cock discharging hot water kept in the hot water storage unit to the outside; and
a pressure adjustment unit for adjusting the pressure of the hot water storage unit when water kept in the hot water storage unit is heated according to an operation of the heating device so as to be thermally expanded to increase pressure in excess of the capacity of the hot water storage unit.

2. The hot water supply device of claim 1, wherein the hot water storage unit is configured to have a form of a tank or a pipe line,

3. The hot water supply device of claim 1, wherein the pressure adjustment unit adjusting the pressure of the hot water storage unit is an auxiliary storage unit configured as a container body having an internal space having a certain size.

4. The hot water supply device of claim 3, wherein an air outlet is formed on the auxiliary storage unit.

5. The hot water supply device of claim 3, wherein an insulating member is provided at an outer side of the auxiliary storage unit.

6. The hot water supply device of claim 3, wherein the auxiliary storage unit is positioned at a lateral side or an upper side of the hot water storage unit.

7. The hot water supply device of claim 1, wherein when a water level in the hot water storage unit is lowered, the water stored in the auxiliary storage unit is returned to the hot water storage unit according to self-weight.

8. The hot water supply device of claim 3, wherein when a water level in the hot water storage unit is lowered, the water stored in the auxiliary storage unit is returned to the hot water storage unit according to self-weight.

9. A cold/hot water dispenser comprising:
an inlet pipe line receiving raw water;
two inflow pipe lines bifurcated from the inlet pipe line;
a hot water storage unit communicating with one of the two inflow pipes and storing hot water heated by the heating device; and
a cold water storage unit communicating with the other of the two inflow pipe lines and storing cold water cooled by the cooling unit,
wherein a pressure adjustment unit for adjusting an increased pressure of the hot water storage unit is provided in the hot water storage unit.

10. The cold/hot water dispenser of claim 9, wherein the pressure adjustment unit for adjusting an increased pressure of the hot water storage unit is an auxiliary storage unit communicating with the hot water storage unit, and an air outlet is formed on the hot water storage unit.
